(19) United States
(12) Patent Application Publication
(10) Pub. No.: US 2006/0132840 A1
(43) Pub. Date: Jun. 22, 2006

(54) Method and system for inquiring facsimile result of multifuntion peripheral

(75) Inventors: Chien-Lung Chen, Taipei (TW); Chun-Wei Chen, Taipei (TW)

Correspondence Address: BACON & THOMAS, PLLC, 625 SLATERS LANE, FOURTH FLOOR, ALEXANDRIA, VA, 22314, US

(73) Assignee: TECO IMAGE SYSTEMS CO., LTD, Taipei (TW)

(21) Appl. No.: 11/113,042

(22) Filed: Apr. 25, 2005

(30) Foreign Application Priority Data
Dec. 22, 2004 (TW) 093140082

(51) Int. Cl. G06F 3/12

(52) U.S. Cl. 358/1.15

(57) ABSTRACT

A method for inquiring a facsimile result of a facsimile machine includes the following steps. Firstly, one or more documents and one or more destination addresses are selected. Then, a facsimile operation is performed to transmit the one or more documents to the one or more destination addresses. Then, a facsimile failure message is issued to a computer when any transmitting error of the one or more documents occurs, and an image of a designated document and a designated destination address involving the transmitting error are stored. Afterward, the web server is communicated with the computer in response to the facsimile failure message so as to inquire the image of the designated document and the designated destination address.

### FIELD OF THE INVENTION

The present invention relates to a method and a system for inquiring a facsimile result, and more particularly to a method and a system for inquiring a facsimile result of a multifunction peripheral.

### BACKGROUND OF THE INVENTION

With increasing power of personal computers, a diversity of peripheral devices can be employed with the personal computers to achieve various purposes. The diverse peripherals, for example printers, facsimile machines, copy machines and scanners, however, occupy lots of space. A multifunction peripheral (MFP) having multiple functions in one structural unit is thus developed.

When a multifunction peripheral is used to perform a facsimile operation, one or more selected documents are successively transmitted to one or more destination facsimile machines. Due to some reasons such as connection interruption, a facsimile failure may occur. Conventionally, when there is facsimile failure, a facsimile result report is shown as the following table.

TABLE
Facsimile result report

| | | | | | | | Total | | |
|---|---|---|---|---|---|---|---|---|---|
| | | | | Transmit/ | | Page | transmitting | | |
| No. | Section | Data | Time | receive | Destination | number | time | Mode | Result |
| 01 | 0001 | SEP. 17 | 07:23 | TX--- | TECO UNION | 002 | 00h02min21s | ECM | NG |

The facsimile result report can notify the user that a transmitting error occurs at certain time spot. From the facsimile result report, however, the user cannot realize which document fails to be normally transmitted to which facsimile machine. Under this circumstance, the user may perform another facsimile operation to transmit all selected documents to all the destination facsimile machines. As known, this approach is time-consuming and waste resources.

Because of the technical defects of described above, the applicant keeps on carving unflaggingly through wholehearted experience and research to develop the present invention, which can effectively improve the problems described above.

### SUMMARY OF THE INVENTION

An object of the present invention is to provide a method and a system for inquiring a facsimile result of a multifunction peripheral so as to realize which document fails to be normally transmitted to which facsimile machine.

In accordance with a first aspect of the present invention, there is provided a method for inquiring a facsimile result of a facsimile machine. Firstly, one or more documents and one or more destination addresses are selected. Then, a facsimile operation is performed to transmit the one or more documents to the one or more destination addresses. Then, a facsimile failure message is issued to a computer when any transmitting error of the one or more documents occurs, and an image of a designated document and a designated destination address involving the transmitting error are stored. Afterward, a web server of the facsimile machine is communicated with the computer in response to the facsimile failure message so as to inquire the image of the designated document and the designated destination address.

Preferably, the facsimile machine is included in a multifunction peripheral.

In an embodiment, the multifunction peripheral further comprises a facsimile server, a mail server and a database.

In an embodiment, the facsimile operation is performed in the facsimile server.

In an embodiment, the facsimile failure message is an e-mail message transmitted from the mail server to the computer via the Internet in response to a triggering signal.

In an embodiment, the triggering signal is issued from the facsimile server when any transmitting error of the one or more documents occurs.

In an embodiment, the image of the designated document and the designated destination address are stored in the database.

In an embodiment, the destination address is a facsimile number of another facsimile machine.

In an embodiment, the method further comprises a step of performing another facsimile operation to transmit the designated document to the designated destination address.

In accordance with a second aspect of the present invention, there is provided a method for inquiring a facsimile result of a facsimile machine. Firstly, one or more documents and one or more destination addresses are selected. Then, a facsimile operation is performed to transmit the one or more documents to the one or more destination addresses. Then, an image of a designated document and a designated destination address involving a transmitting error are stored. Afterward, the web server is communicated with the computer in response to the facsimile failure message so as to inquire the image of the designated document and the designated destination address.

In accordance with a third aspect of the present invention, there is provided a multifunction peripheral for transmitting one or more documents to one or more destination addresses. The multifunction peripheral comprises a facsimile server, a mail server and a web server. The facsimile server is used for performing a facsimile operation to transmit the one or more documents to the one or more destination addresses, issuing a triggering signal when any transmitting error of the one or more documents occurs, and storing an image of a designated document and a designated destination address involving the transmitting error. The mail server is in communication with the facsimile server, and issues a facsimile failure message to a computer in response to the triggering signal. The web server is in communication with the computer. In response to the facsimile failure message, a facsimile result will be inquired by the computer via the web server.

In an embodiment, the multifunction peripheral further comprises a database for storing the image of the designated document and the designated destination address.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a functional block diagram illustrating a system for inquiring a facsimile result of a multifunction peripheral according to a first preferred embodiment;

FIG. 2 is a flowchart illustrating the process for inquiring a facsimile result according to a first preferred embodiment;

FIG. 3 is a functional block diagram illustrating a system for inquiring a facsimile result of a multifunction peripheral according to a second preferred embodiment; and

FIG. 4 is a flowchart illustrating the process for inquiring a facsimile result according to a second preferred embodiment.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

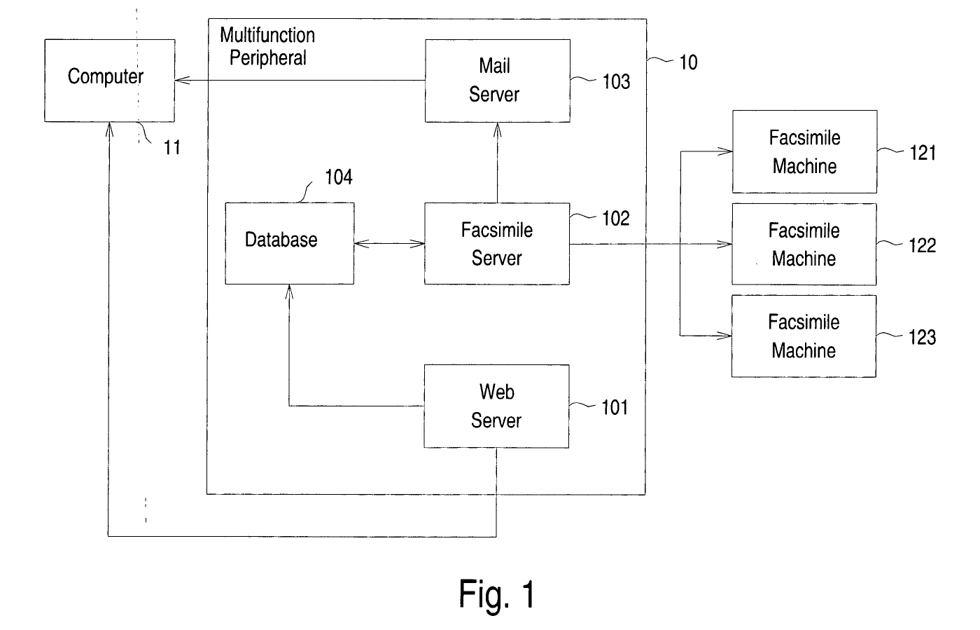

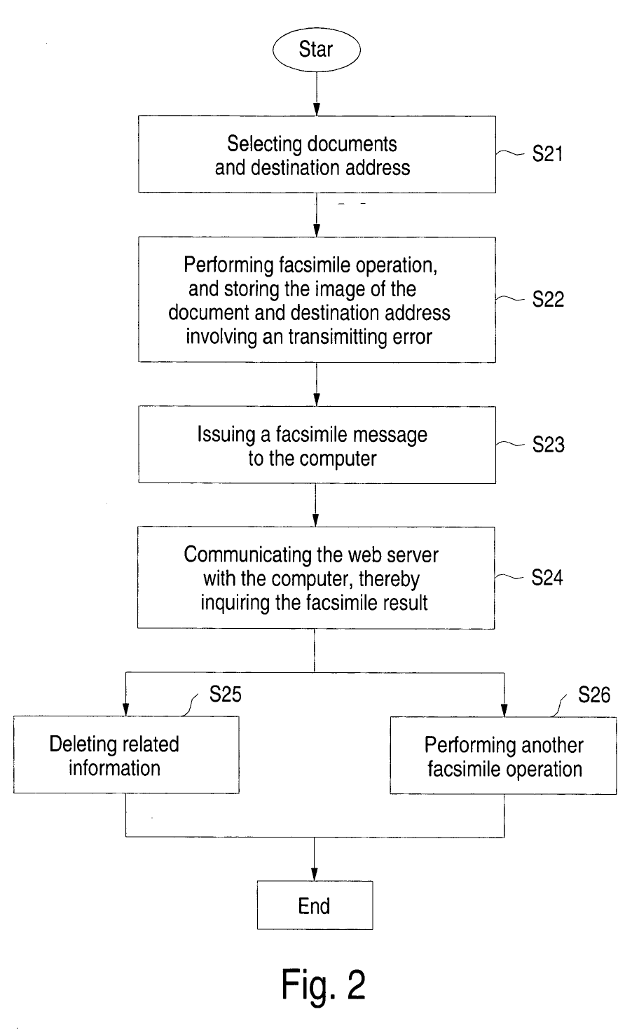

Referring to FIG. 1, a system for inquiring a facsimile result of a multifunction peripheral according to a first preferred embodiment is shown. The system comprises a multifunction peripheral 10 and a computer 11. The multifunction peripheral 10 comprises a web server 101, a facsimile server 102, a mail server 103 and a database 104. The method of using this system to inquire a facsimile result will be illustrated with reference to the flowchart of FIG. 2.

When some selected documents are ready for transmission from the multifunction peripheral 10 to external facsimile machines or multifunction peripherals, for example 121, 122 and 123. The facsimile numbers of the external facsimile machines 121, 122 and 123 should be firstly selected (step S21).

Normally, upon a facsimile operation is performed, the selected documents can be transmitted from the facsimile server 102 to the destination addresses (i.e. the facsimile numbers) of the external facsimile machines 121, 122 and 123. Sometimes, however, a facsimile failure may occur due to many reasons. In a case that any transmitting error of the documents occurs, the image of a designated document and a designated destination address involving the transmitting error are stored in the database 104 (step S22).

Simultaneously, the facsimile server 102 issues a triggering signal to the mail server 103. The contents of the triggering signal include the image of the designated document and the designated destination address involving the transmitting error, which are stored in the database 104. In response to the triggering signal, the mail server 103 issues a facsimile failure message to the computer 11 via the Internet (step S23). In a preferred embodiment, the facsimile failure message is an e-mail message to notify the user that there is a transmitting error.

After the e-mail message is received, the computer 11 is linked to the web server 101 according to the Internet Protocol (IP) address of the multifunction peripheral 10 so as to inquire the facsimile result. The facsimile result includes the image of the designated document and the designated destination address stored in the database 104. Meanwhile, the user can realize which document fails to be normally transmitted to which facsimile machine from the facsimile result (step S24).

According to the facsimile result, the user can decide to delete the information associated with the image of the designated document and the designated destination address (step S25). Otherwise, another facsimile operation can be executed so as to transmit the designated document to the designated destination address (step S26). Since the image of the designated document is stored in the database 104, the user needn't scan the designated document involving the transmitting error again.

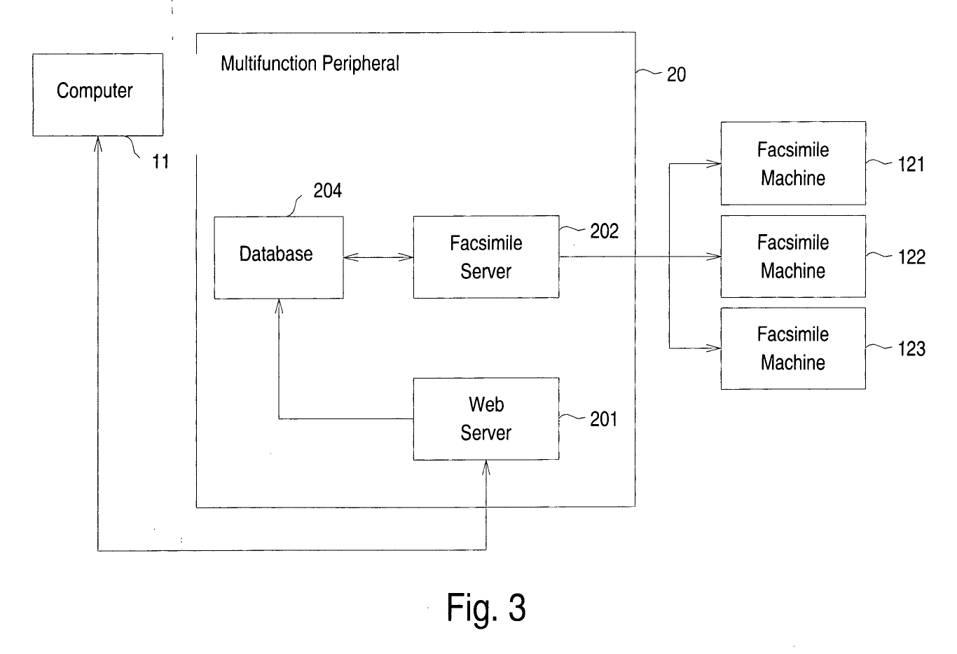

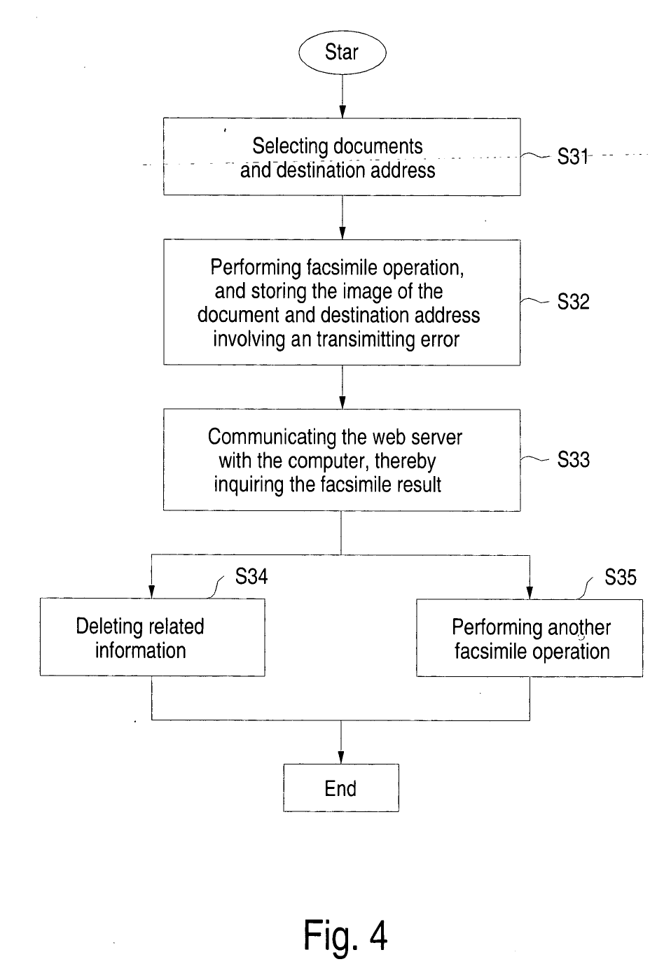

Referring to FIG. 3, a system for inquiring a facsimile result of a multifunction peripheral according to a second preferred embodiment is shown. The system comprises a multifunction peripheral 20 and a computer 11. The multifunction peripheral 20 comprises a web server 201, a facsimile server 202, and a database 204. The method of using this system to inquire a facsimile result will be illustrated with reference to the flowchart of FIG. 4.

When some selected documents are ready for transmission from the multifunction peripheral 20 to external facsimile machines or multifunction peripherals, for example 121, 122 and 123. The facsimile numbers of the external facsimile machines 121, 122 and 123 should be firstly selected (step S31).

Then, a facsimile operation is performed in order to transmit the selected documents from the facsimile server 202 to the destination addresses (i.e. the facsimile numbers) of the external facsimile machines 121, 122 and 123. In a case that any transmitting error of the documents occurs, the image of a designated document and a designated destination address involving the transmitting error is stored in the database 204 (step S32).

Then, the computer 11 is linked to the web server 201 of the multifunction peripheral 20 via the network connection of the computer 11. The facsimile result includes the image of the designated document and the designated destination address stored in the database 204. Meanwhile, the user can realize which document fails to be normally transmitted to which facsimile machine from the facsimile result (step S33).

According to the facsimile result, the user can decide to delete the information associated with the image of the designated document and the designated destination address (step S34). Otherwise, another facsimile operation can be executed so as to transmit the designated document to the designated destination address (step S35). Since the image of the designated document is stored in the database 204, the user needn't scan the designated document involving the transmitting error again.

From the above description, the system and the method of the present invention are capable of inquiring the facsimile results from the database by communicating the computer with the web server. In addition, since the user needn't scan the designated document involving the transmitting error again, the system and the method of the present invention are very user-friendly.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for inquiring a facsimile result of a facsimile machine, said facsimile machine comprising a web server, said method comprising steps of:
selecting one or more documents and one or more destination addresses;
performing a facsimile operation to transmit said one or more documents to said one or more destination addresses;
issuing a facsimile failure message to a computer when any transmitting error of said one or more documents occurs, and storing an image of a designated document and a designated destination address involving said transmitting error; and
communicating said web server with said computer in response to said facsimile failure message, thereby inquiring said image of said designated document and said designated destination address.

2. The method according to claim 1 wherein said facsimile machine is included in a multifunction peripheral.

3. The method according to claim 2 wherein said multifunction peripheral further comprises a facsimile server, a mail server and a database.

4. The method according to claim 3 wherein said facsimile operation is performed in said facsimile server.

5. The method according to claim 3 wherein said facsimile failure message is an e-mail message transmitted from said mail server to said computer via the Internet in response to a triggering signal.

6. The method according to claim 5 wherein said triggering signal is issued from said facsimile server when any transmitting error of said one or more documents occurs.

7. The method according to claim 3 wherein said image of said designated document and said designated destination address are stored in said database.

8. The method according to claim 1 wherein said destination address is a facsimile number of another facsimile machine.

9. The method according to claim 1 further comprising a step of performing another facsimile operation to transmit said designated document to said designated destination address.

10. A method for inquiring a facsimile result of a facsimile machine, said facsimile machine comprising a web server, said method comprising steps of:
selecting one or more documents and one or more destination addresses;
performing a facsimile operation to transmit said one or more documents to said one or more destination addresses;
storing an image of a designated document and a designated destination address involving a transmitting error; and
communicating said web server with a computer, thereby inquiring said image of said designated document and said designated destination address.

11. The method according to claim 10 wherein said facsimile machine is included in a multifunction peripheral.

12. The method according to claim 11 wherein said multifunction peripheral further comprises a facsimile server and a database.

13. The method according to claim 12 wherein said facsimile operation is performed in said facsimile server.

14. The method according to claim 12 wherein said image of said designated document and said designated destination address are stored in said database.

15. The method according to claim 10 wherein said destination address is a facsimile number of another facsimile machine.

16. The method according to claim 10 further comprising a step of performing another facsimile operation to transmit said designated document to said designated destination address.

17. A multifunction peripheral for transmitting one or more documents to one or more destination addresses, comprising:
a facsimile server for performing a facsimile operation to transmit said one or more documents to said one or more destination addresses, issuing a triggering signal when any transmitting error of said one or more documents occurs, and storing an image of a designated document and a designated destination address involving said transmitting error;
a mail server in communication with said facsimile server, and issuing a facsimile failure message to a computer in response to said triggering signal; and
a web server in communication with said computer, and in response to said facsimile failure message, a facsimile result being inquired by said computer via said web server.

18. The multifunction peripheral according to claim 17 wherein said facsimile failure message is an e-mail message transmitted from said mail server to said computer via the Internet in response to a triggering signal.

19. The multifunction peripheral according to claim 17 further comprising a database for storing said image of said designated document and said designated destination address.

20. The multifunction peripheral according to claim 17 wherein said destination address is a facsimile number of another facsimile machine.
